(19) United States
(12) Patent Application Publication
(10) Pub. No.: US 2008/0296314 A1
(43) Pub. Date: Dec. 4, 2008

(54) COMMODITY COLUMN FOR VENDING MACHINE

(75) Inventors: Yuuki YANAGISAWA, Isesaki-shi (JP); Takeshi ONDA, Isesaki-shi (JP); Toshihiko KURIHARA, Isesaki-shi (JP); Masaru TSUNODA, Isesaki-shi (JP); Yoshitaka WATANABE, Isesaki-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: SANDEN CORPORATION, Isesaki-shi (JP)

(21) Appl. No.: 12/130,291

(22) Filed: May 30, 2008

(30) Foreign Application Priority Data
May 31, 2007 (JP) 2007-145105

(51) Int. Cl. G07F 11/16

(52) U.S. Cl. 221/226; 221/224

(57) ABSTRACT

A commodity column for a vending machine in which commodities are arranged in a front-rear direction, a plurality of the commodity columns being placed in a left-right direction in a commodity accommodation chamber, the commodity column having commodity passage members each having a side wall extending in the front-rear direction and a bottom extending from the side wall in one direction along the left-right direction, the commodity passage members being capable of being connected to each other through an extending end of the bottom, and a passage side member capable of being connected to the extending end of the bottom of the commodity passage member. A plurality of the commodity passage members are placed one after another in one direction along the left-right direction, each adjacent pair of the commodity passage members being connected to each other through the extending end. The passage side member is connected to the extending end of the commodity passage member at the outermost end in the one direction along the left-right direction in the commodity passage members. A plurality of commodity array passages are thereby formed in one commodity column, and the total number of commodity columns is set small for a large number of commodity array passages. Spaces for supporting member placement formed between adjacent pairs of the commodity columns are correspondingly reduced to enable the commodity accommodation chamber to have an increased commodity accommodation capacity.

### BACKGROUND OF THE INVENTION

1. Field of the Invention

The present invention relates to a commodity column for a vending machine in which commodities are arranged in a front-rear direction.

2. Description of the Related Art

Among various commodity columns of this kind heretofore proposed, those having a commodity passage formed by a bottom on which commodities are placed and side walls extending on the left-hand and right-hand sides of the bottom are generally known. When a commodity on the commodity column is transported to the outside, commodities at the rear thereof are forced outward by driving a pusher provided on the bottom of the commodity column. In this way, commodities are caused to fall one by one from the foremost row of commodities (as in the case of the commodity column described in Japanese Patent Publication 2006-318258).

When commodities are resupplied to commodity columns, or when commodity columns are repaired, a commodity resupply operation or a repair operation is performed by drawing out each commodity column or removing the commodity column forwardly drawn out. To realize such a drawing-out operation or a repair operation on each commodity column, a supporting member extending in a front-rear direction is formed between each adjacent pair of commodity columns to enable the commodity column to be drawn out by means of the supporting member.

In conventional commodity columns, commodities are arranged in only one row in each column. Commodity columns exist in correspondence with the number of rows of commodities. Also, the number of spaces for placement of supporting members between the commodity columns is large.

Each of spaces for placement of supporting members formed between commodity columns is small. However, since the number of commodity columns is increased, the total of such spaces becomes considerably large. This is a serious cause of a reduction in commodity accommodation capacity of vending machines.

### BRIEF SUMMARY OF THE INVENTION

An object of the present invention is to provide a commodity column for a vending machine capable of minimizing a reduction in commodity accommodation capacity by reducing the number of supporting member placement spaces between commodity columns.

According to the present invention, there is provided a commodity column for a vending machine in which commodities are arranged in a front-rear direction, a plurality of the commodity columns being placed in a left-right direction in a commodity accommodation chamber, the commodity column including commodity passage members each having a side wall extending in the front-rear direction and a bottom extending from the side wall in one direction along the left-right direction, the commodity passage members being capable of being connected to each other through an extending end of the bottom, and a passage side member capable of being connected to the extending end of the bottom of the commodity passage member, wherein a plurality of the commodity passage members are placed one after another in one direction along the left-right direction, each adjacent pair of the commodity passage members being connected to each other through the extending end, and wherein the passage side member is connected to the extending end of the commodity passage member at the outermost end in the one direction along the left-right direction in the commodity passage members.

According to the present invention, the commodity passage members adjacent one another are connected to each other at the common side walls to constitute the commodity column and, therefore, a plurality of commodity array passages are formed in one commodity column. As a result, the total number of commodity columns is reduced and, therefore, supporting member placement spaces are reduced.

These and other objects, features and advantages of the present invention will become apparent from the following description of the invention in conjunction with the accompanying drawings.

### BRIEF DESCRIPTION OF SEVERAL VIEWS OF THE DRAWINGS

FIG. 1 is a font view of a vending machine;

FIG. 2 is an exploded perspective view showing a method of assembling a commodity column;

FIG. 3 is an exploded perspective view of the commodity column;

FIG. 4 is an exploded perspective view of a structure for connection between commodity passage member and a rear end connection member;

FIG. 5 is a perspective view showing a rear connection member supporting structure;

FIG. 6 is a plan view showing placement of a windup spring;

FIG. 7 is a partial front sectional view of the commodity column;

FIG. 8 is a side view of a spacer;

FIG. 9 is a partial front sectional view of the commodity column in a state where the spacer is set;

FIG. 10 is a partial front sectional view of the commodity column showing a modified example of the spacer and a pusher; and

FIG. 11 is a partially cutaway plan view showing another modified example of the pusher.

### DESCRIPTION OF THE PREFERRED EMBODIMENTS

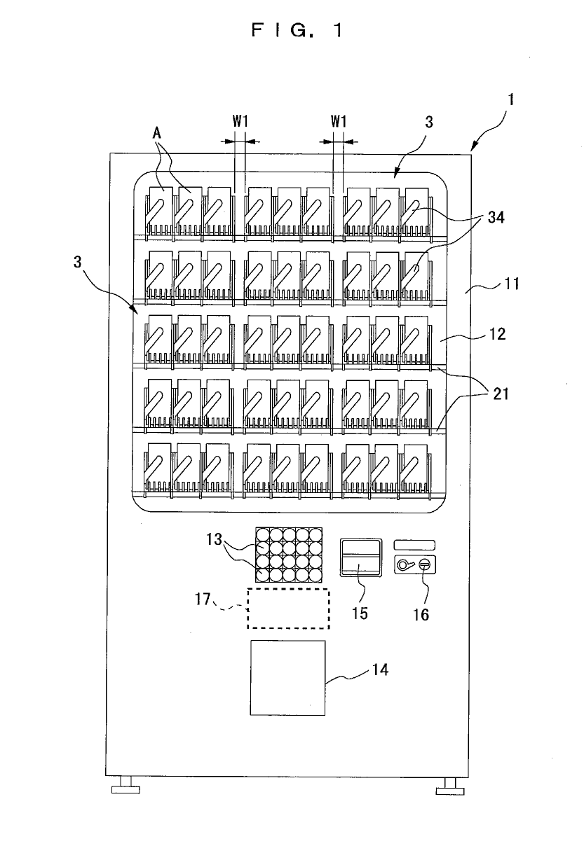

FIGS. 1 to 11 show one embodiment of a commodity column for a vending machine according to the present invention.

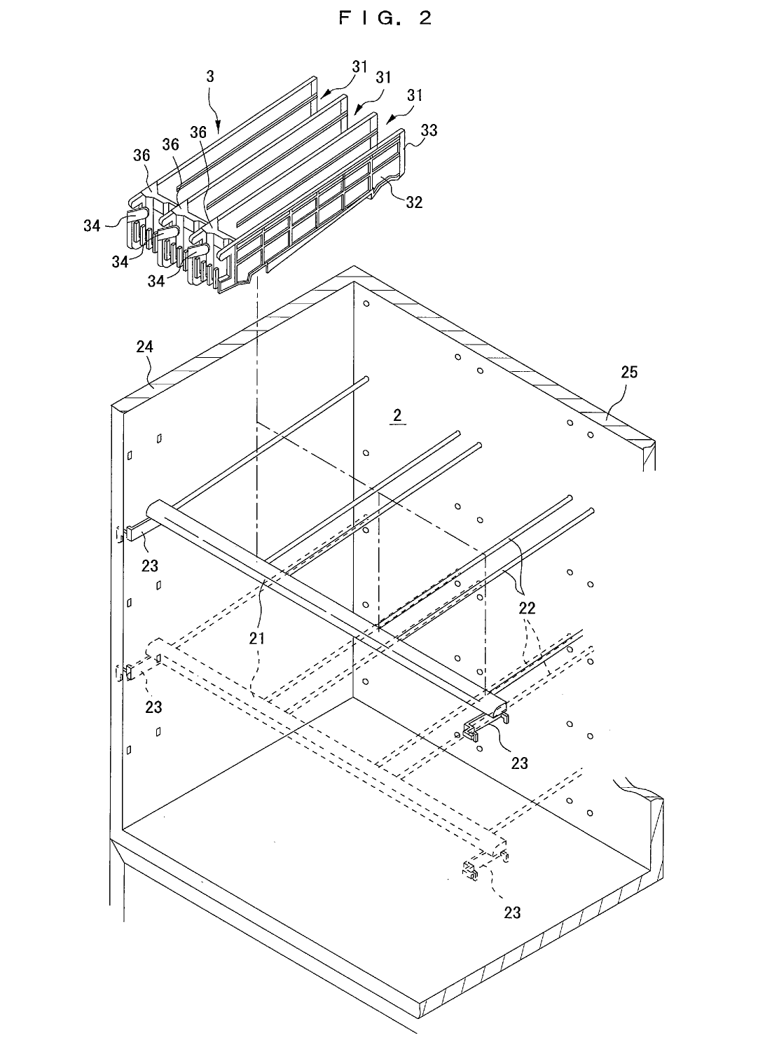

The commodity column according to the present embodiment is provided in a vending machine. The construction of the vending machine will first be outlined with reference to FIGS. 1 and 2.

As shown in FIG. 1, an outer door 11 is openably/closably provided at the front side of a vending machine 1. An accommodation sample section 12, commodity selecting buttons 13, a commodity takeout opening 14, a bill insertion device 15, a coin slot 16, a commodity transport bucket 17 and other components are provided in the outer door 11.

As shown in FIG. 2, a commodity accommodation chamber 2 is formed inside the outer door 11. Inside the commodity accommodation chamber 2, a first supporting member 21 in the form of a plate extending in the left-right direction of the commodity accommodation chamber 2 and a plurality of second supporting members 22 in the form of rods extending in the front-rear direction are provided as members for supporting each of commodity columns 3 described below. The first supporting member 21 supports the commodity column 3 at the front end side. Left and right ends of the first supporting member 21 are fixed by brackets 23 on side walls 24 of the commodity accommodation chamber 2. The second supporting members 22 support the bottom of the commodity column 3 along a front-rear direction. Each second supporting member 22 has its front end inserted and fixed in the first supporting member 21 and has its rear end inserted and fixed in a back wall 25 of the commodity accommodation chamber 2. The commodity column 3 is supported by the first and second supporting members 21 and 22 in the commodity accommodation chamber 2. The bucket 17 shown in FIG. 1 is moved to one of the commodity columns 3 supported as described above. The bucket 17 then receives a commodity A from the commodity column 3 and transports the commodity A to the commodity takeout opening 14.

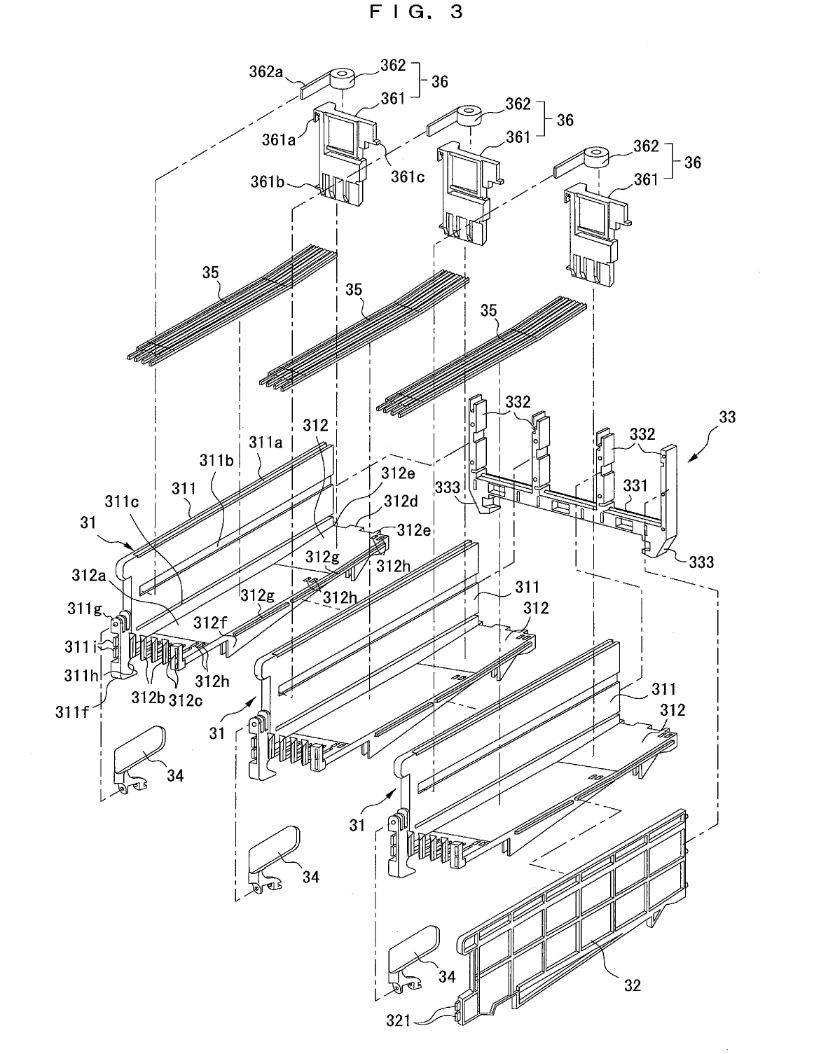

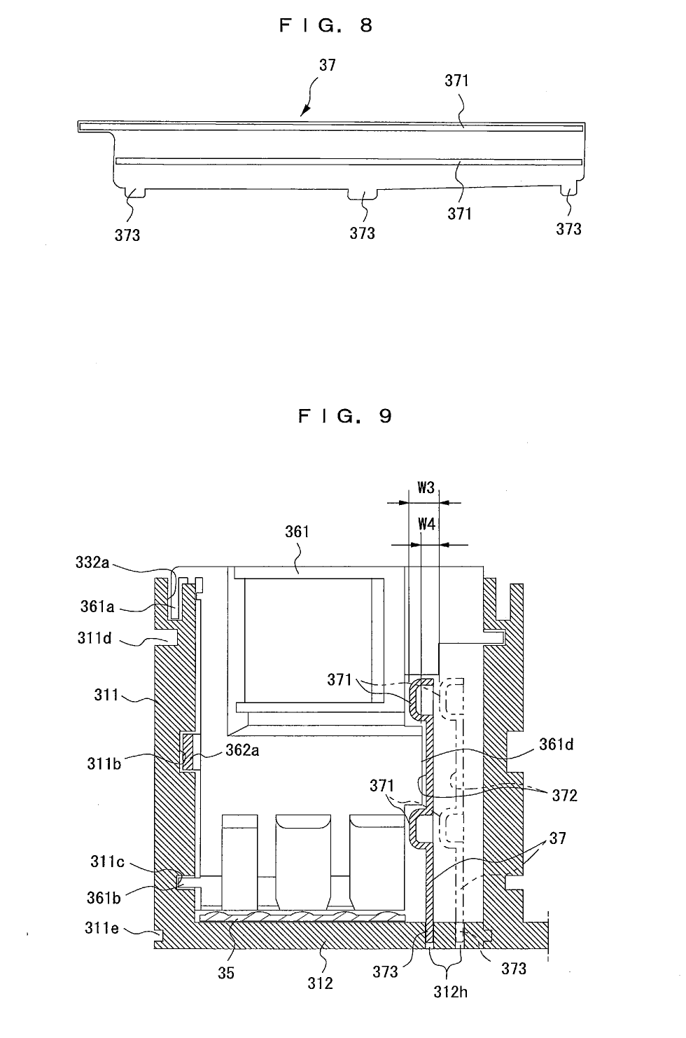

As shown in FIG. 3, the commodity column 3 has three commodity passage members 31, a passage side member 32 connected to the commodity passage members 31, a rear end connection member 33 connected to the commodity passage members 31 and the passage side member 32, gates 34 each of which opens/closes a transport opening of the corresponding one of the commodity passage members 31, sliders 35 for facilitating sliding of commodities in the commodity passage members 31, pushers 36 for forwardly pressing commodities A in the commodity passage members 31, and spacers 37 (shown in FIGS. 8 and 9) for adjusting the commodity passage width.

Description will first be made of the construction of the commodity passage member 31 with reference mainly to FIG. 3. Each commodity passage member 31 is integrally formed of a side wall 311 extending in the front-rear direction and a bottom 312 extending to the right from the side wall 311 as viewed in FIG. 3.

The side wall 311 in the construction of the commodity passage member 31 will be described with reference to FIGS. 3 and 7. As shown in FIG. 3, a first pusher guide groove 311a is formed by grooving an upper end of the side wall 311 in the front-rear direction. A windup spring guide groove 311b of a slightly larger width is formed in an inner surface of the side wall 311 generally at a center of the same in the vertical direction. A second pusher guide groove 311c is also formed in a lower portion of the inner surface of the side wall 311. As shown in FIG. 7, a third pusher guide groove 311d and a passage member connection groove 311e formed by grooving in the front-rear direction are provided in an outer surface of the side wall 311. The third pusher guide groove 311d is positioned slightly lower than the first pusher guide groove 311a, while the passage member connection groove 311e is positioned in a lower portion of the side wall 311.

A gate supporting portion 311f extending downward is formed integrally with a lower front-end portion of the side wall 311, as shown in FIG. 3. A gate mount portion 311g on which the gate 34 is vertically turnably mounted is formed at an upper portion of the gate supporting portion 311f. A receiving recess 311h which can be hooked by a human finger is formed in a lower portion of the gate supporting portion 311f. Engagement claws 311i engageable with the adjacent commodity passage member 31 are formed at a position between the gate mount portion 311g and the receiving recess 311h.

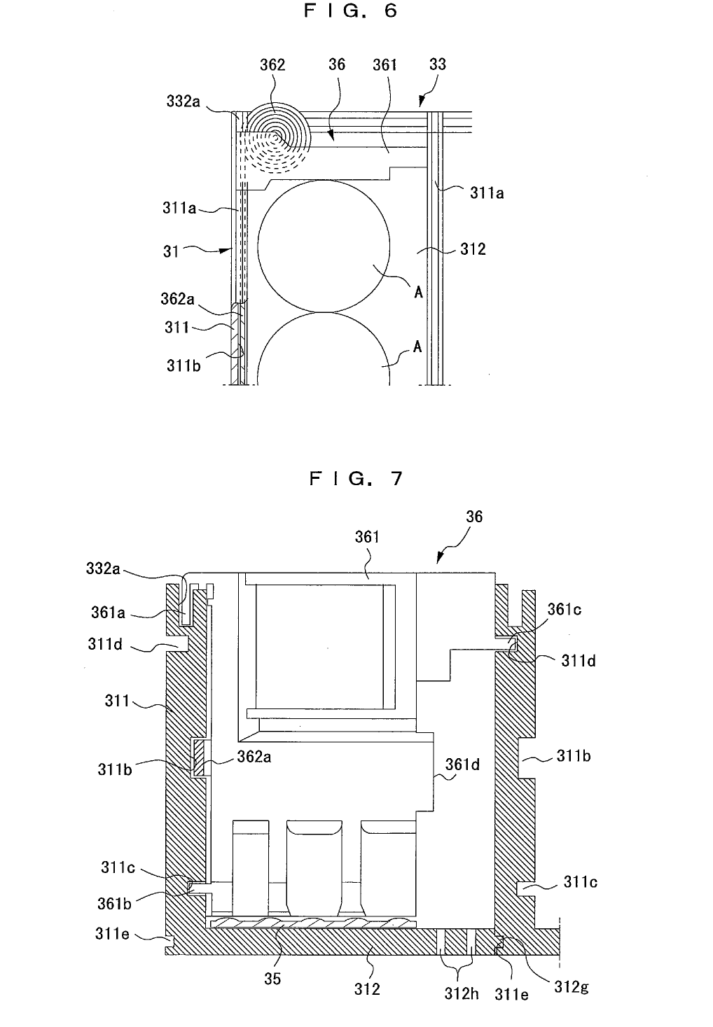

The bottom 312 in the commodity passage member 31 will be described with reference mainly to FIG. 3. The bottom 312 is perpendicularly bent from the lower end of the side wall 311. Commodities A are placed on the bottom 312 in the front-rear direction, as shown in FIG. 6. A design idea of slanting a rear portion of a commodity placement surface 312a of the bottom 312 more steeply than the other portion on the front side is adopted to enable commodities A on the rear side to easily move forward.

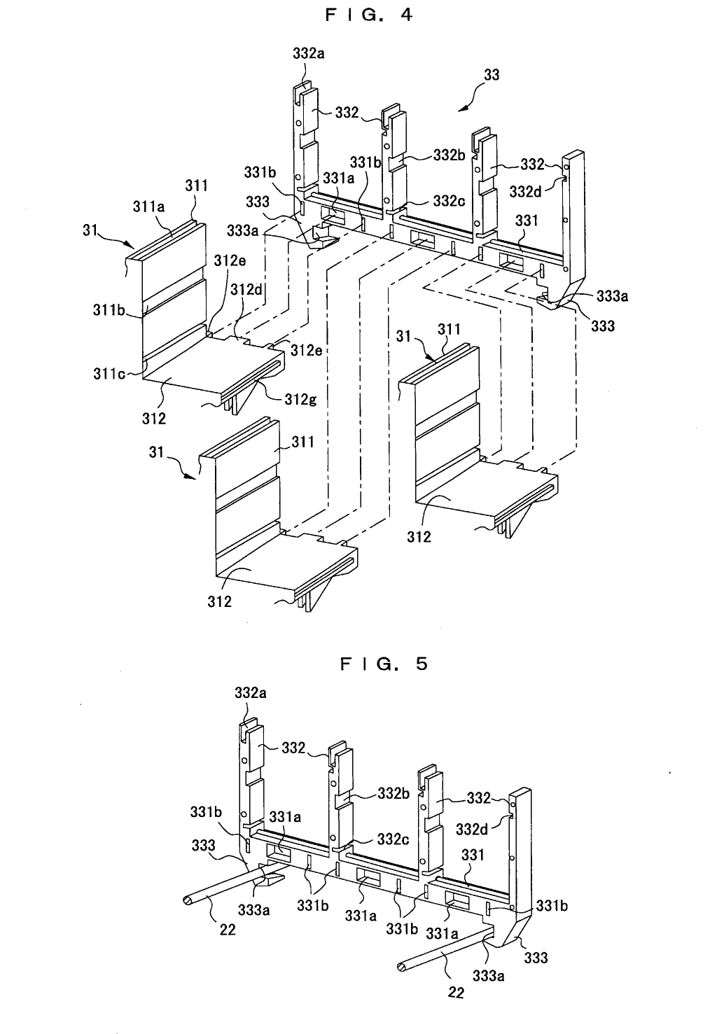

As shown in FIG. 3, falling stop members 312b for preventing commodity A in the foremost row from falling and receiving holes 312c with which the engagement claws 311i of the adjacent commodity passage member 31 engage are provided on the front end of the bottom 312. As shown in FIGS. 3 and 4, a plurality of rear connection projections 312d and 312e extending rearward are provided side by side on the rear end of the bottom 312. The central rear connection projection 312d is formed larger, while the two rear connection projections 312e provided on opposite sides of the rear connection projection 312d is formed smaller. A first support receiving portion 312f bent downward is provided on the extending end of the bottom 312 (on the right-hand side of the bottom 312 as viewed in FIG. 3). Two side connection projections 312g extending in the front-rear direction are protrusively provided on a side surface of the first support receiving portion 312f. The bottom 312 also has a pair of spacer mount holes 312h spaced apart from each other in the left-right direction by a certain distance. Pairs of spacer mount holes 312h are provided in three places in the bottom 312 in the front-rear direction.

The construction of the passage side member 32 will be descried with reference mainly to FIG. 3. The passage side member 32 has the same shape as that of the side wall 311 of the commodity passage member 31. A passage member connection groove (not shown) having the same structure as that of the passage member connection groove 311e formed in the side wall 311 is also formed in a lower portion of the passage side member 32. A third pusher guide groove (not shown) having the same structure as that of the third pusher guide groove 311d is formed in an upper portion of the passage side member 32. Also, engagement claws 321 similar to the engagement claws 311i of the commodity passage member 31 are formed on the front end of the passage side member 32.

The rear end connection member 33 will further be described with reference mainly to FIG. 4. The rear end connection member 33 has a horizontal beam 331 in the form of a rectangular prism, four upright posts 332 disposed at equal intervals on the horizontal beam 331, and second support receiving portions 333 formed so as to extend downwardly from left and right ends of the horizontal beam 331.

As shown in FIG. 4, in the front surface of the horizontal beam 331 are provided projection fitting holes 331a formed in correspondence with the rear connection projections 312d and projection fitting holes 331b formed in correspondence with the rear connection projections 312e. Two projection fitting holes 331b are provided on opposite sides of each projection fitting hole 331a. Three groups of projection fitting holes each consisting of these projection fitting holes 331a and 331b are formed in the horizontal direction (in correspondence with three commodity passage members 31).

In the left three upright posts 332 in the upright posts 332, first guide groove entrances 332a, windup spring guide groove entrances 332b and second guide groove entrances 332c are formed from upper to lower portions. The first guide groove entrances 332a face the first pusher guide grooves 311a. The windup spring guide groove entrances 332b face the windup spring guide grooves 311b. The second guide groove entrances 332c face the second pusher guide grooves 311c. Third guide groove entrances 332d are formed in the right three upright posts 332. The third guide groove entrances 332d face the third pusher guide grooves 311d shown in FIG. 7.

The second support receiving portions 333 have supporting recesses 333a formed by cutting off rectangular inner portions, as shown in FIG. 5. The supporting recesses 333a are formed so as to be larger in diameter than the second supporting members 22. Rear ends of the second supporting members 22 are passed through the supporting recesses 333a with certain play.

As shown in FIG. 1, the gates 34 are members for preventing commodities A positioned at the foremost ends of the commodity passage members 31 from falling. As shown in FIG. 3, the gates 34 are mounted on the gate mount portions 311g of the commodity passage members 31 to open/close the transport openings of the commodity passage members 31.

The sliders 35 are provided on the bottoms 312 of the commodity passage members 31, as shown in FIG. 3. The sliders 35 are formed in correspondence with the entire length of the bottoms 312 in the front-rear direction. The upper surfaces of the sliders 35 are curved in order to reduce frictional resistance to commodities A, thereby enabling commodities A to move smoothly in the front direction.

As shown in FIGS. 6 and 7, each pusher 36 is constituted mainly of rectangular pressing plates 361 extending vertically and a windup spring 362 provided as a drive source. The pusher 36 has the function of pressing the rearmost commodity A forward from a rear position.

An inverse-L-shaped first guide projection 361a is formed on an upper end of the pressing plate 361 on one side. A second guide projection 361b projecting outward is formed on a lower portion of the pressing plate 361. A third guide projection 361c is formed on an upper portion of the pressing plate 361 opposite from the first guide projection 361a. The first guide projection 361a is inserted into the first pusher guide groove 311a through the first guide groove entrance 332a. The second guide projection 361b is inserted into the second pusher guide groove 311c through the second guide groove entrance 332c. The third guide projection 361c is inserted into the third pusher guide groove 311d through the third guide groove entrance 332d. A projecting portion 361d projecting in rectangular form is formed on a side surface of the pressing plate 361 on the third guide projection 361c side.

The windup spring 362 is placed on a rear surface of the pressing plate 361 as shown in FIG. 6. A drawn-out spring portion 362a of the windup spring 362 is placed in the windup spring guide groove entrance 332b and the windup spring guide groove 311b, and the end of the spring portion 362a is connected to a front end portion of the windup spring guide groove 311b. The restoration force of the windup spring 362 is thereby applied as a forward pressing force to the pusher 36 to press the pusher 36 forward.

As shown in FIGS. 8 and 9, each spacer 37 is formed into the shape of a thin long plate having two guide frames 371 spaced apart from each other in the vertical direction. Because the guide frames 371 project inwardly, a recess 372 is formed between the guide frames 371. The recess 372 has such a shape as to surround an outer peripheral edge of the projecting portion 361d of the pusher 36. The spacer 37 also has three mount projections 373 at its lower side. The mount projections 373 are detachably fixed in the spacer mount holes 312h of the bottom 312.

The method of assembling the commodity column 3 constructed as described above will be described with reference mainly to FIG. 3.

Three commodity passage members 31 are first placed in the left-right direction. When the commodity passage members 31 are connected, each commodity passage member 31 is assembled as described below.

The engagement claws 311i of one commodity passage member 31 are inserted in the receiving holes 312c of the adjacent commodity passage member 31 to connect the two commodity passage members at the front end side. The commodity passage members 31 are thereby positioned relative to each other. Subsequently, the side connection projections 312g formed on the extending end of the one commodity passage member 31 are fitted in the passage member connection groove 311e of the adjacent commodity passage member 31 to connect the two commodity passage members, as shown in FIG. 7. In this way, the commodity passage members 31 adjacent to each other in the left-right direction are connected to each other. This connecting operation is repeatedly performed to connect the three commodity passage members 31.

After the completion of the above-described operation for connecting the commodity passage members 31, the passage side member 32 is connected to the side of the commodity passage member 31 at the end of the groups of the commodity passage members 31. That is, the engagement claws 312 of the passage side member 32 are inserted in the receiving holes 312c of the commodity passage member 31, and the side connection projections 312g are simultaneously fitted in the passage member connection groove (not shown) of the passage side member 32, thereby connecting the passage side member 32.

By performing the assembly as described above, one commodity array passage is formed in each commodity passage member 31. Three commodity array passages are thus formed in one commodity column 3.

After the completion of the operation for assembling the commodity passage members 31 and the passage side member 32 performed as described above, the rear end connection member 33 is mounted in a way described below to improve the strength of connection between these members. That is, the rear end connection member 33 is placed at the rear of the commodity passage members 31, with the horizontal beam 331 facing the rear ends of the bottoms 312 of the commodity passage members 31, the upright posts 332 facing the rear ends of the side walls 311 and the passage side member 32, as shown in FIG. 4. Subsequently, the rear connection projections 312d of the commodity passage members 31 are fitted in the projection fitting holes 331a of the rear end connection member 33 and the rear connection projections 312e are fitted in the projection fitting holes 331b. The commodity passage members 31 and the passage side member 32 are thereby firmly connected to each other through the rear end connection member 33. The upright posts 332, the side walls 311 and the passage side member 32 may be fastened, for example, with screws to further increase the connection strength.

After the completion of the operation for connecting the rear end connection member 33 performed as described above, the sliders 35 are placed on the commodity placement surfaces 312a of the commodity passage members 31 and the gates 34 are mounted on the gate mount portions 311g of the commodity passage members 31, as shown in FIG. 3. (The gates 34 may be mounted in advance before assembly of the commodity passage members 31.)

The pushers 36 are thereafter assembled in a way described below. The windup springs 362 are placed on the rear surface of the pressing plates 361. Each pusher 36 is then positioned at the rear of the rear end connection member 33 so as to face the commodity passage member 31. The first guide projections 361a of the pusher 36 is thereafter moved into the first pusher guide groove 311a through the first guide groove entrance 332a; the second guide projection 361b of the pusher 36 into the second pusher guide groove 311c through the second guide groove entrance 332c; and the third guide projection 361c of the pusher 36 into the third pusher guide groove 311d through the third guide groove entrance 332d. On the other hand, the spring portion 362a of each windup spring 362 is placed in the windup spring guide groove 311b through the windup spring guide groove entrance 332b and the end of the spring portion 362a is fixed in the front end portion of the windup spring guide groove 311b.

When the commodity passage width in each commodity passage member 31 is adjusted by the spacer 37, the attachment projections 373 of the spacer 37 may be fixed in the inner or outer spacer mount holes 312h, as shown in FIG. 9.

The commodity column 3 is constructed by the above-described assembly process. When the commodity column 3 is placed in the commodity accommodation chamber 2, a front portion of the commodity column 3 is placed on the first supporting member 21, as shown in FIG. 2, and the second supporting members 22 are inserted in the supporting recesses 333a of the rear end connection member 33, as shown in FIG. 5. In this way, the commodity column 3 is set in the commodity accommodation chamber 2 and the plurality of commodity columns 3 are placed in the commodity accommodation chamber 2, as shown in FIG. 1.

The commodity column 3 according to the present embodiment has the commodity passage members 31 and the passage side member 32. Each commodity passage member 31 has the side wall 311 extending in the front-rear direction and the bottom 312 extending from the side wall 311 in one direction along the left-right direction. The commodity passage members 31 can be connected to each other through the extending ends of the bottoms 312. Also, the commodity passage member 32 can be connected to the extending end of the bottom 312. In this construction, a plurality of commodity passage members 31 are placed one after another in one direction along the left-right direction; each adjacent pair of the commodity passage members 31 are connected to each other through the extending end; and the passage side member 32 is connected through the extending end to the commodity passage member 31 positioned at the outermost end in the one direction along the left-right direction in the commodity passage members 31.

In the commodity column 3 according to the present embodiment, the commodity passage members 31 adjacent one another are connected to each other at the common side walls 311 to constitute the commodity column 3 and, therefore, a plurality of commodity array passages are formed in one commodity column 3. Accordingly, the total number of commodity columns 3 is set small for a large number of commodity array passages. Correspondingly, the number of supporting member placement spaces W1 is reduced to enable the commodity accommodation chamber 2 to have an increased commodity accommodation capacity.

The commodity array passages are formed by the commodity passage members 31 and the passage side member 32. Since the members 31 and 32 are reinforced by the rear end connection member 33, deformation of the commodity array passages or the like can be prevented.

Further, the spring portions 362a of the windup springs 362 (drive source) are placed on the side walls 311 of the commodity passage members 31, and the first to third guide projections 361a to 361c of the pressing plates 361 (guide members) are also supported on the side walls 311 and the passage side member 32. That is, all of the drive sources for the pushers 36 and the guide members are supported on the side walls 311, while corresponding members are supported on the bottom 312 in the related art. As a result, a possibility of deformation of the bottom 312 and a possibility of commodity transport failure due to deformation of the bottom 312, as in the related art, are eliminated.

Further, the projecting portion 361d is formed in the pusher 36 and the recess 372 is formed in the spacer 37 so as to surround the outer peripheral edge of the projecting portion 361d, as shown in FIG. 9. That is, the pusher 36 and the spacer 37 overlap each other as seen in the vertical direction, as indicated by the solid line in FIG. 9. Therefore, even when the spacer 37 is set at a distance from the pusher 36 to increase the passage width (when the guide frames 371 are largely displaced (by W3 in FIG. 9), the distance between the end of the projecting portion 361d and the ends of the recess 372 (W4 in FIG. 9) is limited, as indicated by the double-dot-dash line in FIG. 9, thereby eliminating the possibility of pinching of commodity A in the space between the pusher 36 and the spacer 37.

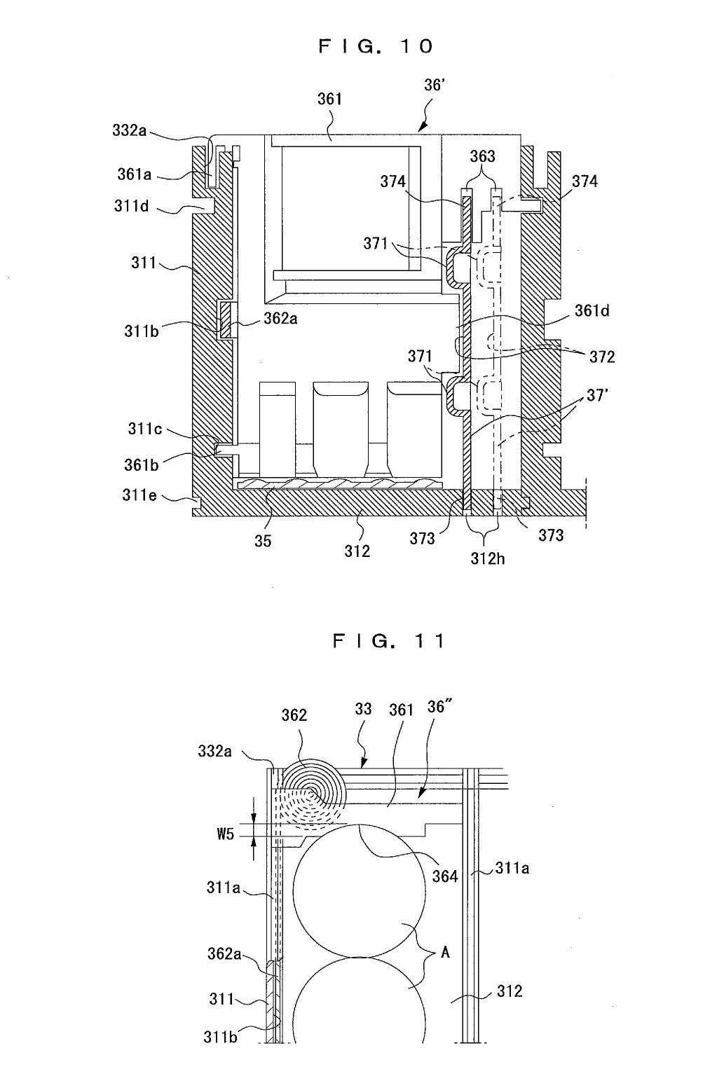

FIG. 10 shows a modified example of the pusher 36 and the spacer 37 according to the above-described embodiment. The same constituent portions as those of the pusher 36 and the spacer 37 according to the above-described embodiment are indicated by the same reference characters.

A spacer 37′ according to this modified example has mount projections 374 extending above the upper guide frame 371, and a pusher 36′ has mount grooves 363 in correspondence with the mount projections 374. This modified example has the advantage of reliably holding the upper and lower ends of the spacer 37′ so that the spacer 37′ is stably set.

FIG. 11 shows another modified example of the pusher 36 according to the above-described embodiment. The same constituent portions as those of the pusher 36 according to the above-described embodiment are indicated by the same reference characters.

A pusher 36″ according to this modified example has a curved recess 364 formed in a portion of the front surface of the pressing plate 361 facing commodity A (front surface central portion) so that the curved recess 364 conforms to the external shape of commodity A.

In the related art, the drive source for pressing is set at a center, so that the thickness of the pressing plate 361 at the front surface center cannot be reduced. In contrast, in this modified example, the drive source (windup spring 362) is one-sidedly set and the width of the pressing plate 361 at the center can be correspondingly reduced (by W5), as shown in FIG. 11, thus achieving the advantage of increasing the commodity accommodation capacity of each commodity passage member 31.

In the above-described embodiment, the supporting members 21 and 22 for supporting the commodity columns 3 are placed below the commodity columns 3 instead of being placed between the commodity columns 3. However, needless to say, the supporting members may be placed between the commodity columns 3.

1. A commodity column for a vending machine in which commodities are arranged in a front-rear direction, a plurality of the commodity columns being placed in a left-right direction in a commodity accommodation chamber, the commodity column comprising:
a commodity passage members each having a side wall extending in the front-rear direction and a bottom extending from the side wall in one direction along the left-right direction, the commodity passage members being capable of being connected to each other through an extending end of the bottom; and
a passage side member capable of being connected to the extending end of the bottom of the commodity passage member,
wherein a plurality of the commodity passage members are placed one after another in one direction along the left-right direction, each adjacent pair of the commodity passage members being connected to each other through the extending end, and
wherein the passage side member is connected to the extending end of the commodity passage member at the outermost end in the one direction along the left-right direction in the commodity passage members.

2. The commodity column for a vending machine according to claim 1, wherein a rear end of each commodity passage member and a rear end of the passage side member are integrally connected to each other through a rear end connection member.

3. The commodity column for a vending machine according to claim 1, further comprising a pusher supported on the side wall of each commodity passage member, the pusher pushing forward the commodities arranged on the commodity passage member.

4. The commodity column for a vending machine according to claim 2, further comprising a pusher supported on the side wall of each commodity passage member, the pusher pushing forward the commodities arranged on the commodity passage member.

5. The commodity column for a vending machine according to claim 3, wherein an upper portion of the pusher is supported on upper portions of the side walls adjacent thereto in the left-right direction, and a lower portion of the pusher is supported on at least one of the side walls adjacent thereto in the left-right direction.

6. The commodity column for a vending machine according to claim 4, wherein an upper portion of the pusher is supported on upper portions of the side walls adjacent thereto in the left-right direction, and a lower portion of the pusher is supported on at least one of the side walls adjacent thereto in the left-right direction.

7. The commodity column for a vending machine according to claim 5, wherein a passage-width-adjusting spacer facing a side surface of the pusher is provided on each commodity passage member, and one of portions of the pusher and the spacer facing each other has a projecting portion projecting toward the other portion, while the other portion has a recess formed so as to surround the outer peripheral edge of the projecting portion.

8. The commodity column for a vending machine according to claim 6, wherein a passage-width-adjusting spacer facing a side surface of the pusher is provided on each commodity passage member, and one of portions of the pusher and the spacer facing each other has a projecting portion projecting toward the other portion, while the other portion has a recess formed so as to surround the outer peripheral edge of the projecting portion.

9. The commodity column for a vending machine according to claim 7, wherein a lower end of the spacer is supported on the bottom of the commodity passage member, and an upper end of the spacer is loosely fitted in the pusher.

10. The commodity column for a vending machine according to claim 8, wherein a lower end of the spacer is supported on the bottom of the commodity passage member, and an upper end of the spacer is loosely fitted in the pusher.
